(19) United States
(12) Patent Application Publication
(10) Pub. No.: US 2003/0054296 A1
(43) Pub. Date: Mar. 20, 2003

(54) Process for forming etched metal ruler with design handle

(76) Inventor: David Howell, Katonah, NY (US)

Correspondence Address: Bernhard P. Molldrem, Jr., 333 East Onondaga Street, Syracuse, NY, 13202, US

(21) Appl. No.: 09/954,501

(22) Filed: Sep. 19, 2001

(51) Int. Cl. G03C 5/00; B44C 1/22; C03C 15/00; C03C 25/68; C23F 1/00

(52) U.S. Cl. 430/329; 216/33; 216/49; 430/318

(57) ABSTRACT

A ruler or similar flat article is provided with an upstanding handle in the form of a decorative design. The ruler and handle may be formed by a photoetch or chemical milling process, with full etching through the metal at edges and partial etching at the design elements in the body portion and handle portion. The handle portion can be unitarily formed and bent at a partially etched join line, and then reinforced using a solder or a braze. Brass or another metal may be used. The partially etched design detail in the handle portion creates a textured surface that facilitates gripping.

### BACKGROUND OF THE INVENTION

This invention relates to flat articles, such as rulers, and is more particularly concerned with a flat article in which an upstanding portion serves as a handle. The invention also relates to the process for creating the article, i.e., ruler, which may be chemical milling or photoetching.

The process or method of chemical milling or photoetching can be used to create articles of a desired shape and design from a sheet of an etchable material, such as a sheet of brass. In this process, the designer provides a plan or design for the article, e.g., a mechanical drawing. Then a “tool” is created of the article, based on the plan or design, and this typically comprises photographic film. The tool is in two parts, with a first phototool that contains the lines defining where the sheet is to be etched through, i.e., fully etched. In this invention, these would constitute edges of the main body portion and edges of the handle portion. There is also a second phototool that is intended to be in register with it, and contains design elements that define where the sheet is to be partially etched, i.e., half-etched. That is, the design elements are to result in grooves and depressions that constitute a textural features on the surface of the metal. The brass sheet is coated on both sides with a photoresist, i.e., a material, which can be film or liquid, that is sensitive to light, and will form a protective coat where exposed to light. Then the phototool is placed on brass sheet and light is exposed onto the coated brass sheet through the phototool(s) The exposed coated sheet is developed, and the areas not exposed to light wash away to expose the brass material. Then the developed coated brass sheet is run through a chemical etching machine, which uses acid or another reagent to etch the exposed brass. Later the photoresist that is still on the sheet material is stripped, and the etched pieces can be subjected to further processing, as needed for a particular application.

A number of rulers have been proposed to which a handle has been attached or affixed, e.g., Brady U.S. Pat. No. 5,615,488, and Phan U.S. Pat. No. 5,769,782. However, in the past, the handle portion has been a large three-dimensional piece, which required some means of fitting onto the ruler or blade. As such, the articles have not been susceptible to taking on an ornamental appearance, nor has it been possible to form them unitarily with the blade, e.g., by a chemical milling or etch procedure. Moreover, none of these prior proposed handled rulers has been embued with an elegant and attractive appearance.

### OBJECTS AND SUMMARY OF THE INVENTION

It is an object of this invention to provide a process or method of creating a ruler or other flat article with an upstanding handle portion that may be in the form of an attractive design, and which represents a distinctive advance over the prior art.

It is a more specific object of this invention to provide a process for forming a ruler or other flat article of simple, elegant, yet sturdy design, in which the handle portion may have a textured surface to increase grip.

It is a more particular object to provide a chemical etch process for forming such articles.

In accordance with an aspect of the present invention, a ruler or similar flat article is formed by a process that involves etching a metal sheet material to form a body portion and a handle portion, where the metal sheet material is etched fully, i.e., through the thickness of the metal, at edges of the body portion and the handle portion, and is etched partly through the metal sheet material at design elements on the body portion and the handle portion. Then the handle portion is oriented a predetermined angle, e.g., 90 degrees, along an edge of the body portion at a join line between said handle portion and said body portion. There may be a line of a solder or braze applied along the join line, as a reinforcement. The design elements on handle portion, being half-etched, create a textured surface thereof to facilitate gripping. The handle portion and body portion may unitarily formed, in which case the handle is bent up at the join line, which may be a half-etched line. Alternatively, the handle portion and body portion may be formed as separate elements and are joined by braze or solder. The handle may be formed as an ornamental design, and may make the article itself suitable as a gift or memento. That is, the handle design may be a representation of a museum piece, famous building or historic landmark.

In one preferred embodiment, the article may be a ruler, and the design elements may include markings appearing at regular intervals along one edge of the body portion.

The etchable metal sheet material may be brass, or may be another metal or metallic material that is subject to chemical milling, including stainless steel.

The above and many other objects, features, and advantages of this invention will become apparent from the ensuing description of selected preferred embodiments, which should be read in conjunction with the accompanying Drawing.

### BRIEF DESCRIPTION OF THE DRAWING

FIG. 1 is plan view of a portion of a metal sheet coated with photoresist and exposed to show design elements to be etched according to one embodiment of this invention.

FIG. 2 is a plan view of an etched article at an intermediate stage after etching.

FIG. 3 is a perspective view for explaining the bending of the article at the join line between the body portion and handle portion thereof according to an embodiment of this invention.

FIGS. 4, 5, and 6 are a top plan view, a side elevation, and an end elevation of a handled ruler according to an embodiment of the invention.

### DETAILED DESCRIPTION OF THE PREFERRED EMBODIMENTS

A ruler with a handle, or other similar flat article with upstanding handle, may be created by etching the same from a sheet or sheets of a suitable metal, such as a brass. In this case a conventional etching process may be employed, and adapted to this purpose.

In a preferred mode for carrying out the process of this invention, a first step is to create a phototool, which may be thought of as a photographic negative or negatives, or transparency or transparencies of the article that is to be produced. In this case there are two portions of the phototool. A first portion carries the solid areas that are used to define the areas that are to be fully etched, that is, etched all the way through the material. A second portion carries the design detail that creates areas that are to be etched only partly into the material, i.e., half-etched.

The brass sheet is laminated or coated on both sides with a photoresist, which may be film or liquid. Then the coated brass sheet is exposed to light through the phototool, so that the portions of the photoresist that are exposed to light become resistant to acid. The exposed coated sheet is then placed in a developer, and the areas exposed to light become cured while those areas not exposed, i.e., masked behind the phototool, are washed away leaving the metal uncovered. The brass sheet is then sent through a chemical etching or chemical milling machine, which uses a reagent, i.e., acid, to etch the exposed metal. Then after this any remaining photoresist on the metal sheet is stripped away, leaving the etched workpieces.

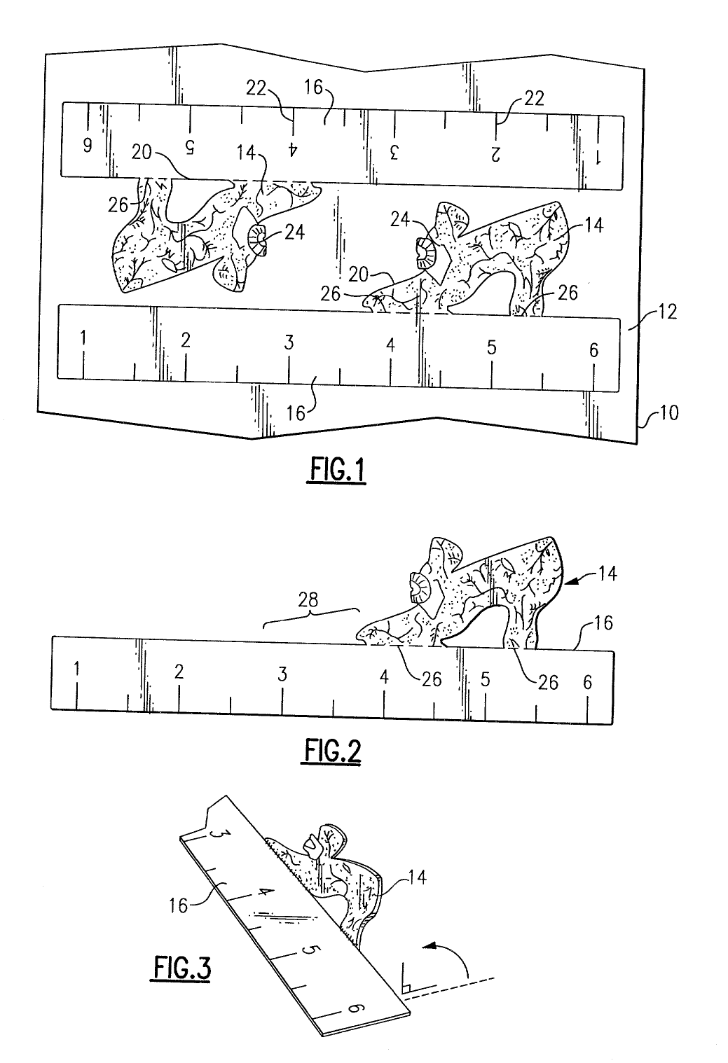

As shown in FIG. 1, a portion of a brass sheet 10 has been coated with a photoresist 12. The reverse surface, not shown here, would be similarly coated. A pattern for the article is shown here after exposure through the phototool, creating a handle portion 14, in the shape of an ornate woman's shoe and which is joined to a body portion 16 of the article, which here is a flat ruler having inch markings along one edge.

The photoresist 12 here has created upon it lines 20 which represent the areas that are to be etched all the way through the metal; design elements 22 on the body portion 16, here in the form of gradations or indicia along one straight edge of the ruler or body portion 16, and design detail 24 representing lines, swirls, and other design elements within the shoe or handle portion 14. The design elements 22 and detail 24 are intended to be etched only partly through the thickness of the metal sheet. Also, a join line 26 is shown here (as dash lines), defining a junction between the handle portion 14 and the body portion 16, and this is to be only partly etched. Several of these articles may be created on the same brass sheet in a single etch process.

FIG. 2 shows the workpiece after the etch process, here a flat piece formed of the shoe-shaped handle portion 14 joined to the ruler or body portion 16, and both lying in one plane. The handle and body portions 14, 16 are unitarily joined at the partly-etched join line 26. Then, the handle portion 14 may be bent up from the body portion 16 at the join line 26, as shown in FIG. 3, until the handle portion is upstanding at an angle, here at a right angle, with respect to the ruler or body portion 16.

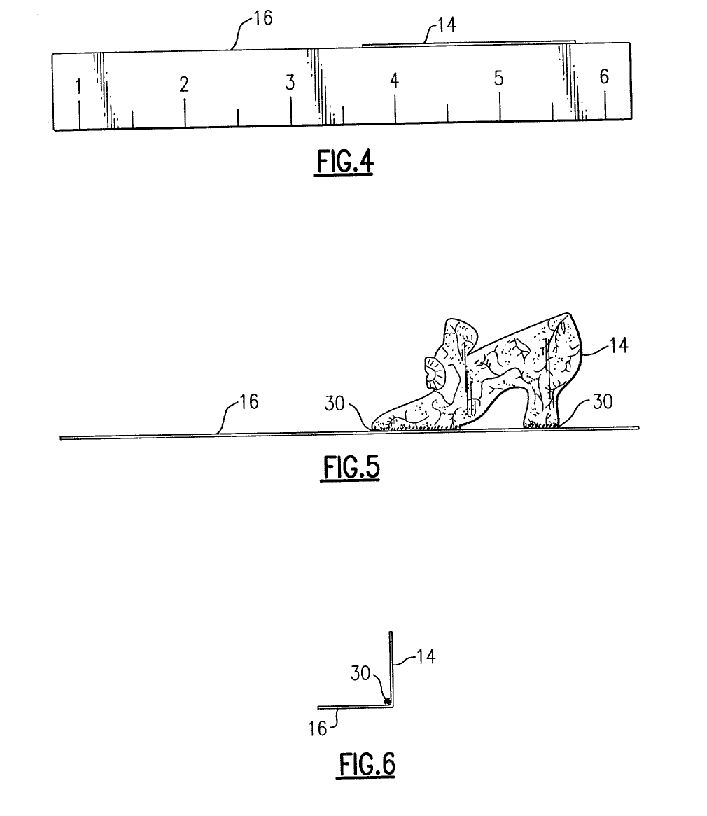

The resulting ruler with unitary handle is shown in plan, side elevation and end elevation in FIGS. 4, 5 and 6, respectively. The handle portion 14 is joined along one edge of the body portion 16. A bead of solder 30 is applied at the inside of the bend at the join line 26 between the handle and body portions, and serves to strengthen or reinforce the juncture of those two elements. If preferred, a braze can be used instead.

In an alternative embodiment, the handle portion 14 and the body portion 16 are separate members, and are not joined until after the etching operation. This technique increases the part yield, i.e., reduces the amount of brass wastage. In this case, the handle portion 14 is affixed onto the edge of the ruler or body portion by means of the braze or solder operation. Also, in this arrangement, a footing can be formed at the base of each of the handle portions, which would be bent at 90 degrees to the remainder of the handle portion, and the base can be soldered or brazed to the body portion.

The partly-etched detail, e.g., at 24, within the handle portion 14 forms a textured surface that allows the user's fingers a better grip than if it were a smooth surface. The design detail may be on one surface or on both front and back surfaces.

Depending upon the design chosen for the handle portion, there may be parts of the handle portion that are etched through. Also, the present invention is not limited to rulers, but may include any article having a flat portion, and which may be formed by etching or chemical milling using a process like those described above.

While the present invention has been described in detail in respect to selected preferred embodiments, the invention is not limited to those embodiments. Rather, many modifications and variations are possible without departure from the scope and spirit of this invention, as defined in the appended claims.

I claim:

1. A method of forming an article having a flat body portion and an upstanding handle portion affixed thereto at an angle, comprising the steps of:
a) forming a photoetch tool of said article including a first tool member having lines for defining edges of the article and a second tool member having design elements defining portions to be partially etched;
b) coating a sheet of an etchable metal with a photoresist;
c) exposing the photoresist coated sheet to illumination through said photoetch tool;
d) developing the exposed coated sheet to remove exposed portions of the photoresist therefrom to create article edges to be fully etched through said sheet and design elements to be etched partially through said sheet;
e) subjecting the metal sheet to an etching process to remove metal from the portions not coated with said photoresist;
f) stripping remaining photoresist to leave said body portion and said handle portion; and
g) orienting and affixing said handle portion at said angle to said body portion.

2. Method according to claim 1 wherein said step of forming the phototool second tool member includes forming design detail to be partially etched into one or both surfaces of said handle portion, so that the resulting handle portion has at least one textured surface, thereby facilitating gripping.

3. Method according to claim 1 wherein said handle and body portions are formed unitarily and joined to one another at a join line, and said step of orienting and affixing includes bending the handle portion from said body portion at said join line.

4. Method according to claim 3 further comprising reinforcing said join line with solder.

5. Method according to claim 3 wherein said forming the photoetch tool second tool member includes forming an element thereon defining said join line, and said subjecting includes partially etching said join line.

6. Method according to claim 1 wherein said article includes a ruler and said second phototool design elements include markings appearing at regular intervals along one edge of said body portion.

7. Method according to claim 1 wherein said metal is brass.

8. Process for forming an article having a flat body portion and a flat upstanding handle portion affixed to the body portion, comprising:
etching a metal sheet material to form said body portion and said handle portion, wherein said etching includes etching fully through the metal sheet material at edges of said body portion and said handle portion, and etching partly through the metal sheet material at design elements on said body portion and said handle portion;
orienting said handle portion at a predetermined angle along one edge of said body portion at a join line between said handle portion and said body portion; and
applying a solder or braze along said join line.

9. Process according to claim 8 wherein said etching partly through at design elements on said handle portion creates a textured surface thereof to facilitate gripping.

10. Process according to claim 8 wherein said handle portion and said body portion are unitarily formed.

11. Process according to claim 8 wherein said handle portion and said body portion are formed as separate elements and are joined in said step of orienting.

12. Process according to claim 8 wherein said article includes a ruler and said design elements include markings appearing at regular intervals along one edge of said body portion.

13. An article having a flat body portion and a flat upstanding handle portion affixed to the body portion, wherein said body portion and said handle portion are etched from a metal sheet material, and are etched fully through the metal sheet material at edges of said body portion and said handle portion, and etched partly through the metal sheet material at design elements on said body portion and said handle portion; wherein said handle portion is joined to said body portion at a predetermined angle along one edge of said body portion at a join line between said handle portion and said body portion; and a bead of solder or braze is applied along said join line.

14. The article according to claim 13 wherein the design elements on said handle portion create a textured surface thereon to facilitate gripping.

15. The article according to claim 13 wherein said article includes a ruler and said design elements include markings appearing at regular intervals along one edge of said body portion.
